(19) United States
(12) Patent Application Publication
(10) Pub. No.: US 2020/0028280 A1
(43) Pub. Date: Jan. 23, 2020

(54) CYLINDRICAL MEMBER AND STRUCTURE USING CYLINDRICAL MEMBER

(71) Applicant: CANON DENSHI KABUSHIKI KAISHA, Chichibu-shi (JP)

(72) Inventors: Hisashi SAKAMAKI, Yokohama-shi (JP); Tomoaki YOSHIBA, Chichibu-shi (JP); Junichi TAKAHASHI, Chichibu-shi (JP); Junichi ONOSAKA, Chiba-shi (JP)

(21) Appl. No.: 16/456,240

(22) Filed: Jun. 28, 2019

(30) Foreign Application Priority Data
Jul. 17, 2018 (JP) 2018-134030

(51) Int. Cl. H01R 4/06; H01R 4/02; B32B 1/08; B29C 70/32; C25D 5/56

(52) U.S. Cl. CPC H01R 4/06; H01R 4/029; B32B 1/08; B29K 2105/0872; C25D 5/56; B32B 2255/205; B32B 2255/10; B29C 70/32

(57) ABSTRACT

There is provided with a cylindrical member that can be easily increased in size. The cylindrical member comprises a first cylindrical member that is constituted by a cylindrical fiber reinforced plastic member that has a first metal film on a surface thereof and a second cylindrical member that is constituted by a cylindrical fiber reinforced plastic member that has a second metal film on a surface thereof. The first metal film and the second metal film are joined to each other. The first metal film and the second metal film may be welded to each other. A joining member may pass through a first metal film and a second metal film.

### CROSS-REFERENCE TO RELATED APPLICATION(S)

This application claims priority to and the benefit of Japanese Patent Application No. 2018-134030 filed on Jul. 17, 2018, the entire disclosure of which is incorporated herein by reference.

### BACKGROUND OF THE INVENTION

### Field of the Invention

The present invention relates to a cylindrical member that is constituted by fiber reinforced plastic (hereinafter may be referred to as FRP) members that have surfaces coated with metal and a structure using the cylindrical member.

### Description of the Related Art

FRP has a high specific strength and a high specific rigidity compared to metallic materials and therefore is used as a structural material of various structures such as buildings and flying objects including airplanes and the like and as a material of a cylindrical member such as a roll used in printers, rollers, paper-making machines, film-making machines (roll rotating apparatuses) and the like.

It is known to form a metal film on a surface of a cylindrical member to improve wear resistance and impart conductivity with respect to static electricity or the like.

Japanese Patent Laid-Open No. 07-276538 describes a method for manufacturing a carbon fiber reinforced plastic roll by performing metal plating on a CFRP roll that is formed through filament winding (FW).

### SUMMARY OF THE INVENTION

According to one embodiment of the present invention, a cylindrical member comprises a first cylindrical member that is constituted by a cylindrical fiber reinforced plastic member that has a first metal film on a surface thereof and a second cylindrical member that is constituted by a cylindrical fiber reinforced plastic member that has a second metal film on a surface thereof, wherein the first metal film and the second metal film are joined to each other.

Further features of the present invention will become apparent from the following description of exemplary embodiments (with reference to the attached drawings).

### BRIEF DESCRIPTION OF THE DRAWINGS

FIG. 1 is an external view of a cylindrical member according to one embodiment of the present invention.

FIG. 2A is an enlarged cross-sectional view of a first embodiment.

FIG. 2B is an enlarged cross-sectional view of a second embodiment.

FIG. 3A is an enlarged cross-sectional view of a third embodiment.

FIG. 3B is an enlarged cross-sectional view of a fourth embodiment.

FIG. 4A is an enlarged cross-sectional view of a fifth embodiment.

FIG. 4B is an enlarged cross-sectional view of a sixth embodiment.

FIG. 5A is an enlarged cross-sectional view of a seventh embodiment.

FIG. 5B is an enlarged cross-sectional view of an eighth embodiment.

FIG. 6A is an enlarged cross-sectional view of a ninth embodiment.

FIG. 6B is an enlarged cross-sectional view of a tenth embodiment.

FIG. 7A is an enlarged cross-sectional view of an eleventh embodiment.

FIG. 7B is an enlarged cross-sectional view of a twelfth embodiment.

FIG. 8A is a schematic diagram showing a method for overlaying cylindrical members that differ from each other in diameter and pulling one of the cylindrical members out of the other.

FIG. 8B is a schematic diagram showing a method for overlaying cylindrical members that differ from each other in diameter and pulling one of the cylindrical members out of the other.

### DESCRIPTION OF THE EMBODIMENTS

In order to manufacture a large cylindrical member using the method described in Japanese Patent Laid-Open No. 07-276538 or other methods, large manufacturing equipment is necessary and increasing the size of a cylindrical member was not easy.

One embodiment of the present invention provides a cylindrical member that can be easily increased in size.

In one embodiment of the present invention, reinforcement fibers that are used to form a cylindrical member made of fiber reinforced plastic (FRP) are preferably fibers that have a small flexure amount when a load is applied thereto and have a high elastic modulus and high strength. Examples of such fibers mainly include carbon fibers, glass fibers, aramid fibers, and ceramic fibers. Two or more types of these fibers may be combined. Also, fibers that have a small specific weight and a high specific strength are preferable in terms of significantly reducing the weight, and examples of such fibers include cellulose nanofibers and carbon fibers.

There are no particular limitations on a matrix resin that is used to form a cylindrical member made of FRP, and examples of matrix resins include thermosetting resins such as an epoxy resin, a polyimide resin, an ester-based resin, a urethane resin, a phenolic resin, an alkyd resin, a xylene resin, a melamine resin, a furan resin, and a silicon resin, and thermoplastic resins. Out of these resins, an epoxy resin, an unsaturated polyester resin, and a vinyl ester resin can be used from the standpoint of ease of handling. Also, a combination of two or more resins or a combination of two or more types of fibers can be used as necessary.

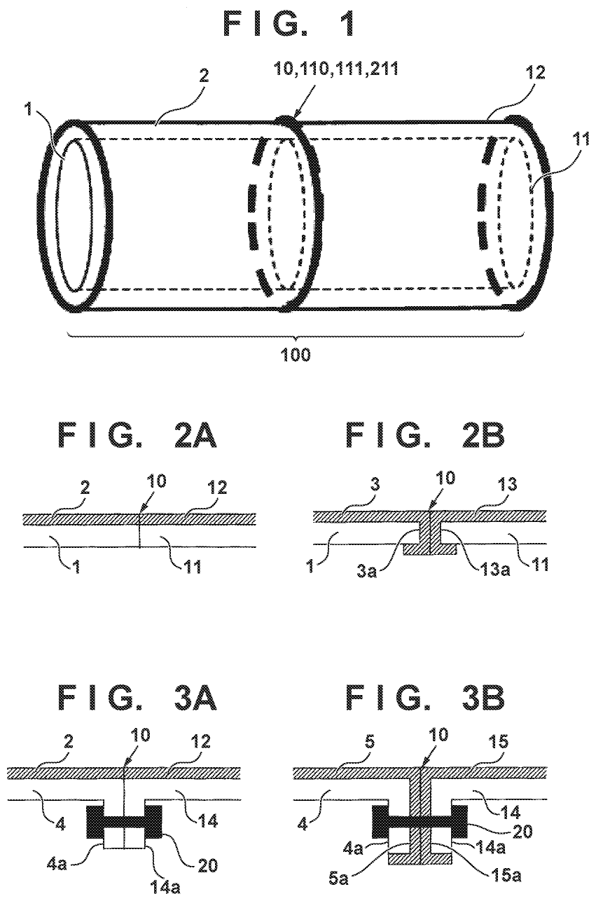

FIG. 1 is a diagram showing an external appearance of a cylindrical member according to one embodiment of the present invention. 1 denotes a cylindrical member that is made of carbon fiber reinforced plastic (CFRP), and an outer periphery of the cylindrical member 1 is directly covered by a metal film (coating) 2 through electroplating without a conductivity-rendering treatment layer or the like being interposed therebetween. 11 denotes a cylindrical member that is made of CFRP although it is hidden by a metal film 12, and, like the cylindrical member 1, an outer periphery of the cylindrical member 11 is directly covered by the metal film (coating) 12 through electroplating without a conductivity-rendering treatment layer or the like being interposed therebetween.

The above-described cylindrical members can be manufactured using the following method. Carbon fibers that constitute a surface layer of the cylindrical member 1 made of CFRP are formed using a method of layering prepreg. Other forming methods such as the FW method and a sheet winding method can also be used. Further, two or more of these forming methods may be combined.

Outer surfaces of the cylindrical members 1 and 11 are ground through machining until carbon fibers are exposed. Grinding may be performed through sanding, shot-blasting, or using a cylindrical grinder, a lathe or the like, and grinding may be omitted according to the state of carbon fibers constituting the surface layer, conductivity of the matrix resin, or the like. Further, carbon black, graphene, or carbon nanotubes may be added to the matrix resin to ensure conductivity.

After the surfaces of the cylindrical members 1 and 11 are ground, the cylindrical members are subjected to electroplating. Electroplating is performed by causing electric currents to flow in a plating solution with the cylindrical members 1 and 11 serving as negative electrodes. In one embodiment of the present invention, any metal that is commonly used in electroplating can be used as plating metal, and examples of plating metals include Cu, Ni, Cr, Au, Ag, Fe, Mn, Co, Zn, Sn, Pd, and Pt, which can be independently used for plating, and alloys obtained by combining two or more of these metals. Alternatively, a plating metal film can be formed through electroless plating.

Also, a plurality of layers that are made of, for example, Cu, Ni, and Cr can be formed through plating. Plating metal to be used can be determined according to required properties. In order to form a plurality of layers of plating metal, plating methods may be combined such as electroless plating being performed after electroplating, or electroplating being performed after electroless plating.

The following describes one embodiment of the present invention in detail with reference to FIGS. 1 to 4.

A cylindrical member 100 shown in FIG. 1 includes a first cylindrical member that is constituted by a cylindrical fiber reinforced plastic member 1 having a first metal film 2 on a surface thereof and a second cylindrical member that is constituted by a cylindrical fiber reinforced plastic member 11 having a second metal film 12 on a surface thereof, and the first metal film 2 and the second metal film 12 are joined to each other via a joint portion 10. In order to ensure conductivity of the joint portion 10, the joint portion 10 may be welded, bonded, or partially plated. Alternatively, joining may be performed using a different type of metal such as solder.

FIGS. 2 to 4 are enlarged cross-sectional views of embodiments showing the joint portion 10 (110, 111, or 211) shown in FIG. 1 for facilitating understanding thereof.

### First Embodiment

FIG. 2A shows an embodiment in which cylindrical members 1 and 11 are electroplated to form metal films 2 and 12, and the metal film 2 and the metal film 12 are joined to each other via a joint portion 10.

### Second Embodiment

FIG. 2B shows an embodiment in which cylindrical members 1 and 11 are electroplated to form metal films 3 and 13 that cover outer surfaces of the cylindrical members 1 and 11 integrally with metal films 3a and 13a that cover end portions of the cylindrical members 1 and 11, and the metal film 3a and the metal film 13a are joined to each other via a joint portion 10. At this time, if cutting or grinding is performed to expose fibers at the end portions of the cylindrical members 1 and 11, plating can be performed so as to cover the end portions of the cylindrical members 1 and 11. Compared to the first embodiment, plating layers are less likely to peel off from fiber-resin composite layers.

Further, the metal films are formed so as to cover the end portions of the cylindrical members in the longitudinal direction and fold back portions are formed in the metal films, resulting in an increase in areas of the metal films, and therefore the metal films can be in contact with each other in a large area and attachment is facilitated.

### Third Embodiment

FIG. 3A shows an embodiment in which bent portions 4a and 14a, which are fold back portions, are formed in end portions of cylindrical members 4 and 14, the cylindrical members 4 and 14 are electroplated to form metal films 2 and 12, and the metal film 2 and the metal film 12 are joined to each other via a joint portion 10. Further, the bent portion 4a that protrudes from the end portion of the cylindrical member 4 toward the center of the cylinder and the bent portion 14a that protrudes from the end portion of the cylindrical member 14 toward the center of the cylinder are joined to each other using a rivet 20 that serves as a joining member. Therefore, the joint is reinforced and detachment is less likely to occur compared to the first embodiment.

### Fourth Embodiment

FIG. 3B shows an embodiment in which bent portions 4a and 14a, which are fold back portions, are formed in end portions of cylindrical members 4 and 14, and the cylindrical members 4 and 14 are electroplated to form metal films 5 and 15 that cover outer surfaces of the cylindrical members 4 and 14 integrally with metal films 5a and 15a that cover end portion sides of the bent portions 4a and 14a in the longitudinal direction of the cylindrical members. Further, the metal film 5a and the metal film 15a are joined to each other via a joint portion 10, and the bent portions 4a and 14a that protrude from the end portions of the cylindrical members 4 and 14 toward the centers of the cylinders are joined to each other using a rivet 20. The rivet 20 passes through the metal film 5a and the metal film 15a. Compared to the first embodiment, plating layers are less likely to peel off from fiber-resin composite layers, and the joint is reinforced and detachment is less likely to occur.

Further, the metal films are formed so as to cover the end portions of the cylindrical members in the longitudinal direction and fold back portions are formed in the metal films, resulting in an increase in areas of the metal films, and therefore the metal films can be in contact with each other in a large area and attachment is facilitated.

### Fifth Embodiment

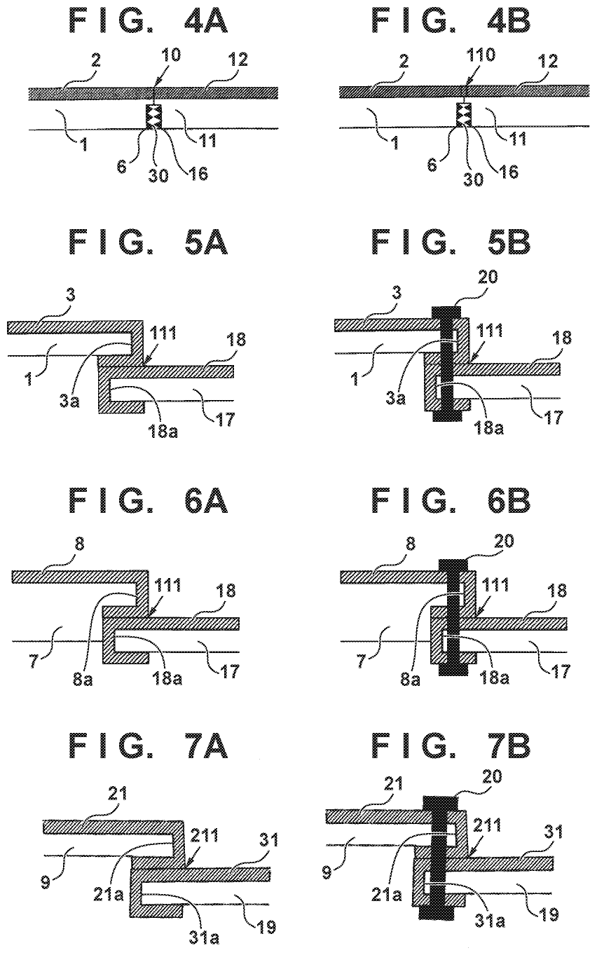

FIG. 4A shows an embodiment in which irregular-surface members 6 and 16 are solidified in a state of being attached to end portions of cylindrical members 1 and 11, and the cylindrical members 1 and 11 are electroplated to form metal films 2 and 12. The metal film 2 and the metal film 12 are joined to each other via a joint portion 10, recessed portions of the members 6 and 16 are filled with resin 30, and the resin 30 is solidified through heating to bond together the irregular-surface members 6 and 16 via the resin 30. Compared to the first embodiment, the joint is reinforced and detachment is less likely to occur.

### Sixth Embodiment

FIG. 4B shows an embodiment in which irregular-surface members 6 and 16 are solidified in a state of being attached to end portions of cylindrical members 1 and 11, and the cylindrical members 1 and 11 are electroplated to form metal films 2 and 12. In a state where there is a space between the metal film 2 and the metal film 12, bonding is performed by solidifying resin 30 through heating, and a joint portion 110 for electrically joining the metal film 2 and the metal film 12 to each other is formed using solder or the like. Compared to the first embodiment, the joint between the cylindrical members is reinforced and detachment is less likely to occur.

In the fifth and sixth embodiments, cylindrical members made of CFRP may be solidified in a state where cylindrical metal portions 6 and 16 (irregular-surface members) are arranged in end portions of the cylindrical members in the longitudinal direction so that the cylindrical members are formed integrally with the cylindrical metal portions 6 and 16. In a case where the cylindrical metal portions 6 and 16 are bonded to the end portions of the cylindrical members in the longitudinal direction, if irregularities are formed in surfaces of the cylindrical metal portions 6 and 16 through anodic oxidation or the like, the metal portions are less likely to peel off owing to the anchor effect. For example, irregular-surface members obtained through anodic oxidation of duralumin are preferably used, and the metal portions 6 and 16 may be metal films. A cylindrical member may be bonded to another cylindrical member via the cylindrical metal portion 6, or the metal portion 16 may also be bonded to an end portion of the other cylindrical member in the longitudinal direction and the cylindrical members may be bonded to each other by filling a space between the metal portion 6 and the metal portion 16 with resin. It should be noted that, if the cross-sectional area of an irregular-surface member that is used for joining is set smaller than the cross-sectional area of the whole cylindrical member including the metal portion 6 and the cylindrical member, joining of the cylindrical members can be performed while keeping the weight from becoming too large.

Any two or more of the above-described embodiments may be combined.

### Seventh Embodiment

FIG. 5A shows an embodiment in which cylindrical members 1 and 17 that differ from each other in diameter are electroplated to form metal films 3 and 18 that cover outer surfaces of the cylindrical members 1 and 17 integrally with metal films 3a and 18a that cover end portions of the cylindrical members 1 and 17, and the metal film 3a and the metal film 18 are joined to each other via a joint surface 111. Compared to the first embodiment, plating layers are less likely to peel off from fiber-resin composite layers.

Furthermore, detachment is less likely to occur because the joint surface is large, and attachment is facilitated because the area of contact between the metal films is large.

### Eighth Embodiment

FIG. 5B shows an embodiment in which cylindrical members 1 and 17 that differ from each other in diameter are electroplated to form metal films 3 and 18 that cover outer surfaces of the cylindrical members 1 and 17 integrally with metal films 3a and 18a that cover end portions of the cylindrical members 1 and 17, the metal film 3a and the metal film 18 are joined to each other via a joint surface 111, and further the metal film 3 and the metal film 18a are joined to each other using a rivet 20. The rivet 20 passes through the cylindrical members 1 and 17 and the metal films 3a and 18. Compared to the first embodiment, plating layers are less likely to peel off from fiber-resin composite layers, and the joint is reinforced and detachment is less likely to occur.

Occurrence of detachment is further suppressed because the joint surface is large, and attachment is facilitated because the area of contact between the metal films is large.

### Ninth Embodiment

FIG. 6A shows an embodiment in which a cylindrical member 7 that has a step portion and a cylindrical member 17 that differs from the cylindrical member 7 in diameter are electroplated to form metal films 8 and 18 that cover outer surfaces of the cylindrical members 7 and 17 integrally with metal films 8a and 18a that cover end portions of the cylindrical members 7 and 17, and the metal film 8a and the metal film 18 are joined to each other via a joint surface 111. Compared to the first embodiment, plating layers are less likely to peel off from fiber-resin composite layers.

Furthermore, detachment is less likely to occur because the joint surface is large, and attachment is facilitated because the area of contact between the metal films is large and positioning can be performed through abutment.

### Tenth Embodiment

FIG. 6B shows an embodiment in which a cylindrical member 7 that has a step portion and a cylindrical member 17 that differs from the cylindrical member 7 in diameter are electroplated to form metal films 8 and 18 that cover outer surfaces of the cylindrical members 7 and 17 integrally with metal films 8a and 18a that cover end portions of the cylindrical members 7 and 17, the metal film 8a and the metal film 18 are joined to each other via a joint surface 111, and further the metal film 8 and the metal film 18a are joined to each other using a rivet 20. The rivet 20 passes through the cylindrical members 7 and 17 and the metal films 8a and 18. Compared to the first embodiment, plating layers are less likely to peel off from fiber-resin composite layers, and the joint is reinforced and detachment is less likely to occur.

Occurrence of detachment is further suppressed because the joint surface is large, and attachment is facilitated because the area of contact between the metal films is large and positioning can be performed through abutment.

### Eleventh Embodiment

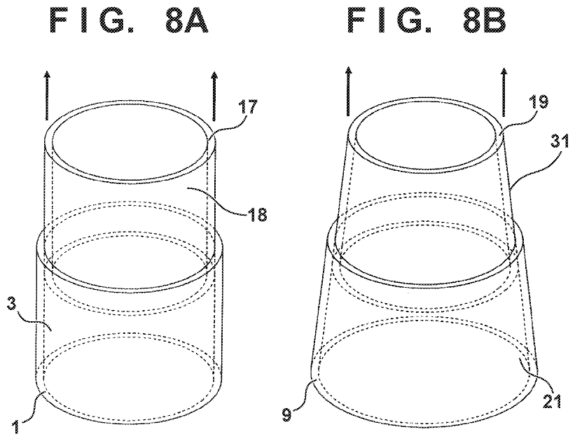

FIG. 7A shows an embodiment in which cylindrical members 9 and 19 that differ from each other in diameter and each have a taper angle with respect to the longitudinal direction of the cylindrical members are electroplated to form metal films 21 and 31 that cover outer surfaces of the cylindrical members 9 and 19 integrally with metal films 21a and 31a that cover end portions of the cylindrical members 9 and 19, and the metal film 21a and the metal film 31 are joined to each other via a joint surface 211. Compared to the first embodiment, plating layers are less likely to peel off from fiber-resin composite layers.

Furthermore, attachment is facilitated because the cylindrical members have taper angles and positioning can be performed by merely overlaying the cylindrical members on each other and pulling one of the cylindrical members out of the other.

### Twelfth Embodiment

FIG. 7B shows an embodiment in which cylindrical members 9 and 19 that differ from each other in diameter and each have a taper angle with respect to the longitudinal direction of the cylindrical members are electroplated to form metal films 21 and 31 that cover outer surfaces of the cylindrical members 9 and 19 integrally with metal films 21a and 31a that cover end portions of the cylindrical members 9 and 19, the metal film 21a and the metal film 31 are joined to each other via a joint surface 211, and further the metal film 21 and the metal film 31a are joined to each other using a rivet 20. The rivet 20 passes through the cylindrical members 9 and 19 and the metal films 21a and 31. Compared to the first embodiment, plating layers are less likely to peel off from fiber-resin composite layers, and the joint is reinforced and detachment is less likely to occur.

Furthermore, attachment is facilitated because the cylindrical members have taper angles and positioning can be performed by merely overlaying the cylindrical members on each other and pulling one of the cylindrical members out of the other.

FIGS. 8A and 8B show methods for overlaying cylindrical members that differ from each other in diameter as shown in FIGS. 5A, 5B, 7A, and 7B and pulling one of the cylindrical members out of the other. The cylindrical member 17 has a smaller diameter than the cylindrical member 1. In the example shown in FIG. 8A, the cylindrical members are arranged such that the metal film 18 covering the outer surface of the cylindrical member 17 is disposed on the inner side of the metal film 3 covering the outer surface of the cylindrical member 1 as shown in FIG. 5, and then the cylindrical member 17 is pulled up. After the cylindrical member 17 is pulled up to a predetermined position, the cylindrical member 1 and the cylindrical member 17 are joined to each other.

The cylindrical member 19 having a taper angle has a smaller diameter than the cylindrical member 9 having a taper angle. In the example shown in FIG. 8B, the cylindrical members are arranged such that the metal film 31 covering the outer surface of the cylindrical member 19 is disposed on the inner side of the metal film 21 covering the outer surface of the cylindrical member 9, and then the cylindrical member 19 is pulled up. After the cylindrical member 19 is pulled up to a predetermined position, the cylindrical member 9 and the cylindrical member 19 are joined to each other.

At this time, one fixing portion or a plurality of fixing portions may be provided to fix the cylindrical member to means for pulling up. If at least one of the outer cylindrical member and the inner cylindrical member is moved in the vertical direction, the cylindrical members that differ from each other in diameter can be joined together in a state where flexure in the gravitational direction is suppressed. It should be noted that, if a cylindrical member that has a smaller diameter is moved, joining can be performed while flexure is further suppressed.

### Example 1

CFRP prepreg (TR380G250S, manufactured by Mitsubishi Chemical Corporation) was arranged in a desired direction such as an axial direction, a direction that crosses the axis, or a helix direction on a mandrel with a diameter of 190 mm and a length of 1000 mm, and then the prepreg was solidified through heating and the mandrel was extracted to obtain a CFRP tube with a diameter of 200 mm and a length of 1000 mm.

Thereafter, sanding was performed on an outer surface and an inner surface of the CFRP tube to expose carbon fibers. Conductivity of the outer surface and the inner surface of the CFRP tube was checked using a tester. Copper electroplating was performed through a conventional method in a copper sulfate solution with the CFRP tube serving as a negative electrode until a plating film with a thickness of 50 m was formed to obtain a CFRP tube coated with metal.

Another CFRP tube coated with metal was produced through the same method, and the CFRP tubes were bonded to each other via a joint surface to obtain a CFRP tube coated with metal and having a diameter of 200 mm and a length of 2000 mm.

If cylindrical members as those of this example are used, it is possible to significantly reduce the length of a mandrel that is necessary in a process of manufacturing FRP tubes, and it is also possible to reduce the size of a plating bath that is used in a process of coating the FRP tubes with metal.

What is claimed is:

1. A cylindrical member comprising:
a first cylindrical member that is constituted by a cylindrical fiber reinforced plastic member that has a first metal film on a surface thereof; and
a second cylindrical member that is constituted by a cylindrical fiber reinforced plastic member that has a second metal film on a surface thereof,
wherein the first metal film and the second metal film are joined to each other.

2. The cylindrical member according to claim 1,
wherein the first metal film and the second metal film are welded to each other.

3. The cylindrical member according to claim 1, further comprising:
a first bent portion that protrudes from an end portion of the first cylindrical member toward a center of a cylinder;
a second bent portion that protrudes from an end portion of the second cylindrical member toward a center of a cylinder; and
a joining member that passes through the first bent portion and the second bent portion.

4. The cylindrical member according to claim 1, further comprising:
a first bent portion that protrudes from an end portion of the first cylindrical member toward a center of a cylinder and a third metal film that is formed on a surface of the first bent portion; and
a second bent portion that protrudes from an end portion of the second cylindrical member toward a center of a cylinder and a fourth metal film that is formed on a surface of the second bent portion,
wherein the third metal film and the fourth metal film are joined to each other.

5. The cylindrical member according to claim 4,
wherein the first metal film and the third metal film are plating films that are formed integrally with each other, and
the second metal film and the fourth metal film are plating films that are formed integrally with each other.

6. The cylindrical member according to claim 4, further comprising
a joining member that passes through the first bent portion and the second bent portion and joins the first cylindrical member and the second cylindrical member to each other.

7. The cylindrical member according to claim 1, further comprising
a joining member that passes through the first metal film and the second metal film.

8. A structure using the cylindrical member according to claim 1.
